(19) United States
(12) Patent Application Publication
(10) Pub. No.: US 2024/0163083 A1
(43) Pub. Date: May 16, 2024

(54) TRAIL COLLECTION SYSTEM, TRAIL COLLECTION METHOD, TRAIL PROVISION APPARATUS, TRAIL PROVISION METHOD, AND COMPUTER-READABLE MEDIUM

(71) Applicant: NEC Corporation, Minato-ku, Tokyo (JP)

(72) Inventor: Keisuke Ina, Tokyo (JP)

(73) Assignee: NEC Corporation, Minato-ku, Tokyo (JP)

(21) Appl. No.: 18/281,892

(22) PCT Filed: Mar. 18, 2021
(86) PCT No.: PCT/JP2021/011211

§ 371 Date: Sep. 13, 2023

(51) Int. Cl. H04L 9/08; H04L 9/32

(52) U.S. Cl. CPC H04L 9/0825; H04L 9/3247

(57) ABSTRACT

A trail management system (2000) includes a trail acquisition apparatus (2100) and a trail provision apparatus (2200). The trail acquisition apparatus (2100) reads first identification information from a symbol (20) attached to a managed object (10), and transmits a request (40) including the first identification information. The trail provision apparatus (2200) receives the request (40), and determines whether the first identification information included in the request (40) matches second identification information stored in a storage unit (2280) of the trail provision apparatus (2200). In a case where the information matches, the trail provision apparatus (2200) transmits a response (50) including trail information or a hash value of the trail information. The trail acquisition apparatus (2100) receives the response (50).

### TECHNICAL FIELD

The present disclosure relates to a technique of managing a trail of a managed object.

### BACKGROUND ART

Systems for managing a trail of a device or the like have been developed. For example, Patent Literature 1 discloses a system for managing a trail of each device in a blockchain.

### CITATION LIST

### Patent Literature

[Patent Literature 1] Japanese Unexamined Patent Application Publication No. 2019-004391

### SUMMARY OF INVENTION

### Technical Problem

The system according to Patent Literature 1 is based on an assumption that a server that registers a trail of a device receives identification data transmitted from that device. The present disclosure has been made in view of such a problem, and an objective of the present disclosure is to provide a novel technique for collecting a trail of a managed object.

### Solution to Problem

A trail collection system according to the present disclosure includes a trail provision apparatus and a trail acquisition apparatus.

The trail acquisition apparatus includes: a read unit configured to read, from a symbol attached to a managed object, first identification information represented by the symbol; a transmission unit configured to transmit a request including the first identification information; and a reception unit configured to receive a response.

The trail provision apparatus includes: a reception unit configured to receive the request; a determination unit configured to determine whether the first identification information included in the request matches second identification information stored in the trail provision apparatus; and a transmission unit configured to transmit, when the first identification information matches the second identification information.

The response including trail information stored in the trail provision apparatus or the response including a hash value of the trail information.

A trail collection method according to the present disclosure is executed by a trail provision apparatus and a trail acquisition apparatus. In the trail collection method, the trail acquisition apparatus reads, from a symbol attached to a managed object, first identification information represented by the symbol; the trail acquisition apparatus transmits a request including the first identification information; the trail provision apparatus receives the request; the trail provision apparatus determines whether the first identification information included in the request matches second identification information stored in the trail provision apparatus; the trail provision apparatus, transmits, when the first identification information matches the second identification information, a response including trail information stored in the trail provision apparatus or a response including a hash value of the trail information; and the trail acquisition apparatus receives the response.

A trail provision apparatus according to the present disclosure includes: a reception unit configured to receive a request including first identification information that is read from a symbol attached to a managed object; a determination unit configured to determine whether the first identification information included in the request matches second identification information stored in the trail provision apparatus; and a transmission unit configured to transmit, when the first identification information matches the second identification information, a response including trail information stored in the trail provision apparatus or a response including a hash value of the trail information.

A trail provision method according to the present disclosure is executed by a computer. The trail provision method includes: a reception step of receiving a request including first identification information that is read from a symbol attached to a managed object; a determination step of determining whether the first identification information included in the request matches second identification information stored in the computer; and a transmission step of transmitting, when the first identification information matches the second identification information, a response including trail information stored in the computer or a response including a hash value of the trail information.

A computer-readable medium according to the present disclosure stores a program causing a computer to execute the trail provision method according to the present disclosure.

### Advantageous Effects of Invention

According to the present disclosure, a novel technique for collecting a trail of a managed object is provided.

### BRIEF DESCRIPTION OF DRAWINGS

FIG. 1 is a diagram illustrating an example of an overview of an operation of a trail collection system according to a first example embodiment;

FIG. 2 is a block diagram illustrating an example of a functional configuration of the trail collection system according to the first example embodiment;

FIG. 3 is a block diagram illustrating an example of a hardware configuration of a computer that implements a trail acquisition apparatus 2100;

FIG. 4 is a block diagram illustrating an example of a hardware configuration of a computer that implements a trail provision apparatus 2200; and

FIG. 5 is a flowchart illustrating an example of a flow of processing executed by the trail collection system according to the first example embodiment.

### EXAMPLE EMBODIMENT

Hereinafter, example embodiments of the present disclosure will be described in detail with reference to the drawings. In the drawings, the same or corresponding elements are denoted by the same reference signs, and redundant descriptions are omitted as necessary for clarity of description. Further, unless otherwise specified, values being set in advance, such as a predetermined value and a threshold, are stored in advance in a storage device or the like accessible from an apparatus that uses such value.

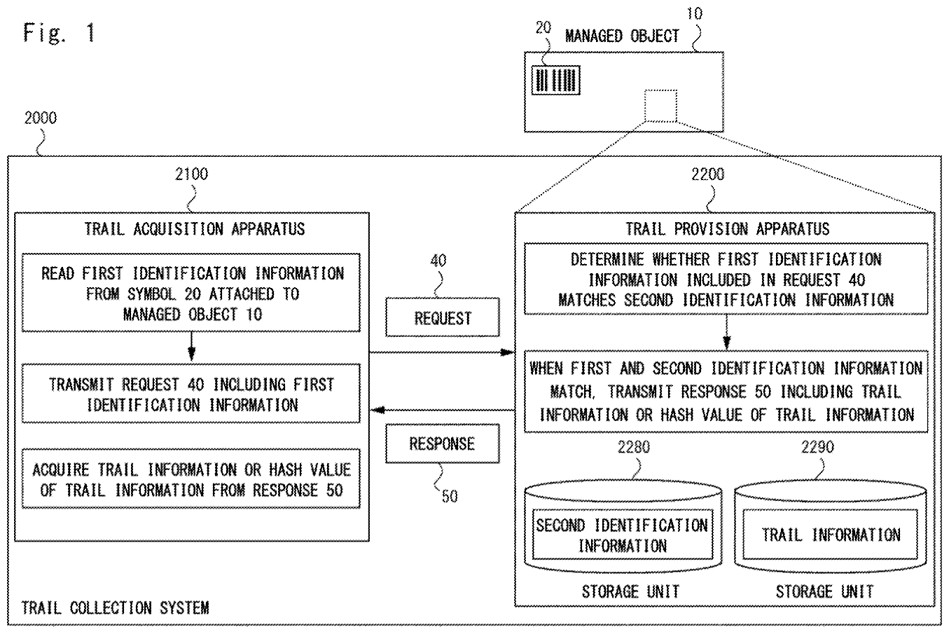

FIG. 1 is a diagram illustrating an example of an overview of an operation of a trail collection system 2000 according to a first example embodiment. Herein, FIG. 1 is a diagram for facilitating understanding of an overview of the trail collection system 2000, and the operation of the trail collection system 2000 is not limited to that illustrated in FIG. 1.

The trail collection system 2000 is a system for managing a trail of a managed object 10. The managed object 10 is any product for which management of a trail thereof is required. An example of such a product is an Internet of Things (IoT) device being used in various facilities such as plants or offices.

The trail collection system 2000 includes a trail acquisition apparatus 2100 and a trail provision apparatus 2200. The trail provision apparatus 2200 provides trail information indicating a trail regarding the managed object 10 or a hash value of the trail information to the trail acquisition apparatus 2100. Herein, the “trail regarding the managed object 10” is information indicating how the managed object 10 has been produced, how the managed object 10 has been operated, or the like (that is, information indicating various histories regarding the production process or the operation process of the managed object 10). Specific examples of the trail regarding the managed object 10 include a product number or a manufacturing time of each component constituting the managed object 10, software information and a change history of software written in the managed object 10, an operation log at the time of operation of the managed object 10, an operation log of internal software, or the like.

The trail collection system 2000 may be the managed object 10 itself or may be an object other than the managed object 10. When the managed object 10 is a kind of a computer, the trail collection system 2000 may be implemented by the managed object 10 itself. When the managed object 10 is not a computer, for example, the trail collection system 2000 may be implemented by a computer (e.g., integrated circuit (IC) chip or the like) provided inside the managed object 10. Note that, even when the managed object 10 is a computer, the trail collection system 2000 may be implemented by another computer provided inside the managed object 10, instead of the managed object 10 itself.

Note that there may be exist a plurality of managed objects 10. In such a case, the trail provision apparatus 2200 are present for each of the plurality of managed objects 10. For example, the trail provision apparatus 2200 for the managed object 10 is provided inside each of the plurality of managed objects 10. In addition, for example, the trail provision apparatus 2200 for the managed object 10 may be implemented by each of the managed objects 10 themselves.

A symbol 20 is attached to the managed object 10. The symbol 20 represents identification information of the managed object 10. For example, the symbol 20 is any code (barcode, two-dimensional code, or the like) representing encoded identification information. In addition, for example, the symbol 20 may be a character string representing the identification information of the managed object 10.

The symbol 20 is attached to the managed object 10 in such a manner that the identification information represented by the symbol 20 can be read. A way of attaching the symbol 20 to the managed object 10 in such a manner may be any way. For example, the symbol 20 is adhered to, drawn on, or printed on the surface of the managed object 10. In addition, for example, the symbol 20 may be engraved on the surface of the managed object 10.

Herein, the identification information of the managed object 10 is also stored in a storage unit 2280 provided inside the trail provision apparatus 2200. The identification information represented by the symbol 20 is referred to as “first identification information”, and the identification information stored in the storage unit 2280 is referred to as “second identification information”.

In addition, in a storage unit 2290 provided inside the trail provision apparatus 2200, the trail information representing the trail of the corresponding managed object 10 is stored. The storage unit 2280 and the storage unit 2290 may be implemented by the same storage device or may be implemented by different storage devices.

The trail acquisition apparatus 2100 reads the first identification information from the symbol 20 attached to the managed object 10 whose trail is to be acquired, and transmits a request 40 including the first identification information. The request 40 is a request for requesting provision of a trail.

As described above, there may exist a plurality of managed objects 10. Hereinafter, the managed object 10 from which the first identification information is read by the trail acquisition apparatus 2100 is also referred to as a “target object”, and is distinguished from the other managed objects 10.

Each trail provision apparatus 2200 acquires the request 40 and determines whether the first identification information being included in the request 40 matches the second identification information stored in the storage unit 2280. When those pieces of information match each other, the trail provision apparatus 2200 transmits a response 50 including the trail information or the hash value of the trail information. The trail information includes information such as a type of the trail, a creator of the trail, a generation date and time of the trail, and a content of the trail.

The trail acquisition apparatus 2100 receives the response and thereby acquires the trail information or the hash value of the trail information. Note that the response 50 may include both the trail information and the hash value of the trail information. Hereinafter, for the sake of brevity, trail information or a hash value of trail information is collectively referred to as trail-related information.

### <Example of Advantageous Effect>

When managing a trail of a product, it is possible to manage the identification information of the product and the trail of the product in association with each other. Further, it is possible that the symbol representing the identification information of the product is attached to the product, and the identification information is read from the symbol to use it for registration of the trail.

In such an operation, there is a possibility that the product is replaced by attaching another symbol or the like. When the trail acquired from the product is registered without noticing such the replacement, correspondence relationship between the identification information of the product and the trail of the product becomes incorrect. That is, the trail of the product becomes incorrect. Therefore, it is preferable that the trail be registered after confirming that the identification information represented by the symbol correctly represents the identification information of the product to which that symbol is attached.

In this regard, the trail acquisition apparatus 2100 transmits a request 40 including the first identification information read from the symbol 20 attached to the managed object 10. In addition, upon receiving the request 40, the trail provision apparatus 2200 transmits the response 50 including the trail-related information when the second identification information stored therein matches the first identification information being included in the request 40. Accordingly, it enables to acquire the trail after confirming that the identification information represented by the symbol 20 attached to the managed object 10 matches the identification information stored in the trail provision apparatus 2200 associated with the managed object 10. Therefore, the authenticity of the trail of the product can be ensured.

Hereinafter, the trail collection system 2000 of the present example embodiment will be described in more detail.

### <Example of Functional Configuration>

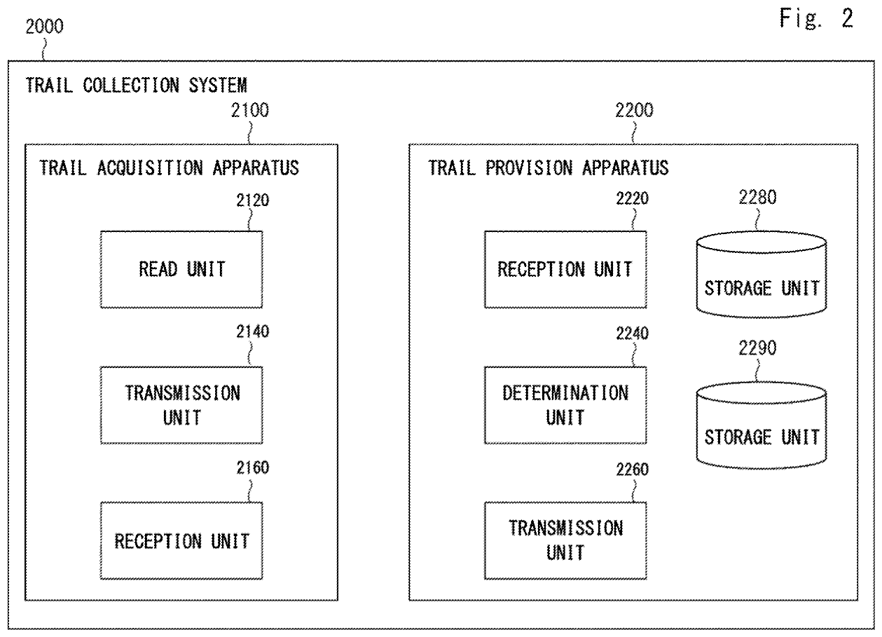

FIG. 2 is a block diagram illustrating an example of a functional configuration of the trail collection system 2000 according to the first example embodiment. The trail collection system 2000 includes the trail acquisition apparatus 2100 and the trail provision apparatus 2200. The trail acquisition apparatus 2100 includes a read unit 2120, a transmission unit 2140, and a reception unit 2160. The read unit 2120 reads the first identification information from the symbol 20 attached to the managed object 10. The transmission unit 2140 transmits the request 40 including the first identification information. The reception unit 2160 receives the response 50 including the trail-related information.

The trail provision apparatus 2200 includes a reception unit 2220, a determination unit 2240, and a transmission unit 2260. The reception unit 2220 receives the request 40. The determination unit 2240 determines whether the first identification information being included in the request 40 matches the second identification information stored in the storage unit 2280. When the first identification information and the second identification information match each other, the transmission unit 2260 transmits the response 50 including the trail-related information.

### <Example of Hardware Configuration of Trail Acquisition Apparatus 2100>

Each functional component of the trail acquisition apparatus 2100 may be implemented by hardware (e.g., a hardwired electronic circuit or the like) that implements each functional component, or may be implemented by a combination of hardware and software (e.g., a combination of an electronic circuit and a program for controlling the electronic circuit, or the like). Hereinafter, a case where each functional component of the trail acquisition apparatus 2100 is implemented by a combination of hardware and software will be further described.

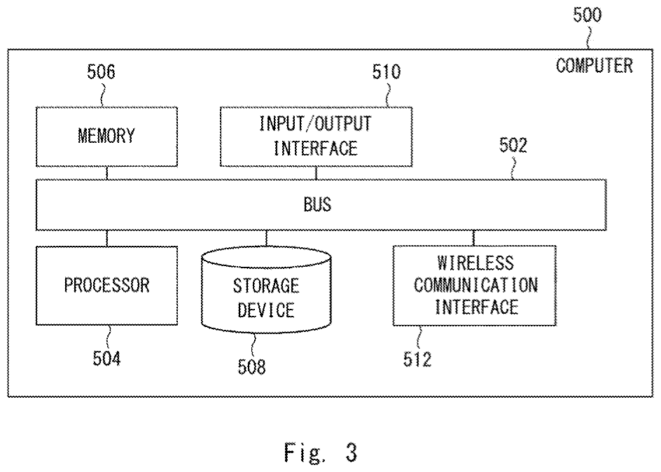

FIG. 3 is a block diagram illustrating an example of a hardware configuration of a computer 500 that implements the trail acquisition apparatus 2100. The computer 500 may be any computer. For example, the computer 500 is a portable computer such as a smartphone or a tablet terminal. The computer 500 may be a special-purpose computer designed to implement the trail acquisition apparatus 2100, or may be a general-purpose computer.

The computer 500 includes a bus 502, a processor 504, a memory 506, a storage device 508, an input/output interface 510, and a wireless communication interface 512. The bus 502 is a data transmission path through which the processor 504, the memory 506, the storage device 508, the input/output interface 510, and the wireless communication interface 512 transmit and receive data to and from one another. However, the method of connecting the processors 504 and the like to one another is not limited to the bus connection.

The processor 504 is a variety of processors, such as a central processing unit (CPU), a graphics processing unit (GPU), or a field-programmable gate array (FPGA). The memory 506 is a primary storage device implemented by using a random access memory (RAM) or the like. The storage device 508 is a secondary storage device implemented by using a hard disk, a solid state drive (SSD), a memory card, a read only memory (ROM), or the like.

The input/output interface 510 is an interface for connecting the computer 500 and an input/output device. For example, an input device such as a keyboard and an output device such as a display device are connected to the input/output interface 510.

The wireless communication interface 512 is an interface for the computer 500 to perform wireless communication with another computer. For example, the wireless communication interface 512 is an interface for wirelessly connecting to a network such as a local area network (LAN) or a wide area network (WAN). In addition, for example, the wireless communication interface 512 may be an interface for performing wireless communication in accordance with a communication standard such as Bluetooth (registered trademark).

The storage device 508 stores a program for implementing each functional component of the trail acquisition apparatus 2100. The processor 504 reads the program into the memory 506 and executes the program, thereby implementing each of the functional components of the trail acquisition apparatus 2100.

The method of acquiring the program may be any method. For example, the program may be acquired from a storage medium (such as a DVD disk or a USB memory) in which such program is stored. In addition, for example, the program may be acquired by downloading the program from a server apparatus that manages a storage device in which the program is stored.

The trail acquisition apparatus 2100 may be implemented by a single computer 500 or may be implemented by a plurality of computers 500. In the latter case, the configuration of each of the computers 500 need not be the same, but may be different.

### <Example of Hardware Configuration of Trail Provision Apparatus 2200>

Each functional component of the trail provision apparatus 2200 may be implemented by hardware (e.g., a hardwired electronic circuit or the like) that implements each functional component, or may be implemented by a combination of hardware and software (e.g., a combination of an electronic circuit and a program for controlling the electronic circuit, or the like). Hereinafter, a case where each functional component of the trail provision apparatus 2200 is implemented by a combination of hardware and software will be further described.

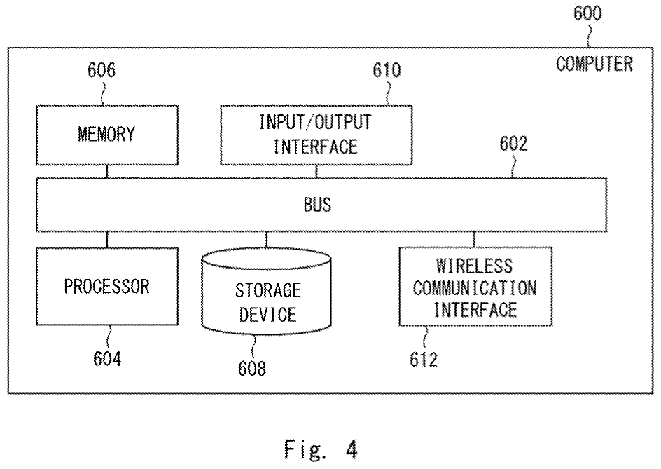

FIG. 4 is a block diagram illustrating an example of a hardware configuration of a computer 600 that implements the trail provision apparatus 2200. The computer 600 may be any computer. For example, the computer 600 is a portable computer such as a smartphone or a tablet terminal. Further, the computer 600 is a stationary computer such as a personal computer (PC) or a server machine. In addition, for example, when the computer 600 is provided inside the managed object 10, the computer 600 may be an IC chip such as a system-on-a-chip (SoC). The computer 600 may be a dedicated computer designed to implement the trail provision apparatus 2200, or may be a general-purpose computer.

The computer 600 includes a bus 602, a processor 604, a memory 606, a storage device 608, an input/output interface 610, and a wireless communication interface 612. The bus 602 is a data transmission path through which the processor 604, the memory 606, the storage device 608, the input/output interface 610, and the wireless communication interface 612 transmit and receive data to and from one another. However, the method of connecting the processor 604 and the like to one another is not limited to the bus connection.

The processor 604 is a variety of processors, such as a central processing unit (CPU), a graphics processing unit (GPU), or a field-programmable gate array (FPGA). The memory 606 is a primary storage device implemented by using a random access memory (RAM) or the like. The storage device 608 is a secondary storage device implemented by using a hard disk, a solid state drive (SSD), a memory card, a read only memory (ROM), or the like.

The input/output interface 610 is an interface for connecting the computer 600 and an input/output device. For example, an input device such as a keyboard and an output device such as a display device are connected to the input/output interface 610.

The wireless communication interface 612 is an interface for the computer 600 to perform wireless communication with another computer. For example, the wireless communication interface 612 is an interface for wirelessly connecting to a network such as a local area network (LAN) or a wide area network (WAN). In addition, for example, the wireless communication interface 612 may be an interface for performing wireless communication in accordance with a communication standard such as Bluetooth (registered trademark).

Note that the wireless communication interface 512 and the wireless communication interface 612 are configured to be able to communicate with each other. For example, the wireless communication interface 512 and the wireless communication interface 612 are connected to the same wireless LAN to perform wireless communication with each other. In addition, for example, the wireless communication interface 512 and the wireless communication interface 612 perform wireless communication with each other in accordance with the same wireless communication standard such as Bluetooth (registered trademark).

The storage device 608 stores a program for implementing each functional component of the trail provision apparatus 2200. The processor 604 reads the program into the memory 606 and executes the program, thereby implements each of the functional components of the trail provision apparatus 2200.

The method of acquiring the program may be any method. For example, the program may be acquired from a storage medium (such as a DVD disk or a USB memory) in which such program is stored. In addition, for example, the program may be acquired by downloading the program from a server device that manages a storage device in which the program is stored.

The storage unit 2280 and the storage unit 2290 are implemented by any storage device included in the trail provision apparatus 2200. The storage device may be the storage device 608 or another storage device. Note that it is preferable to prevent the second identification information stored in the storage unit 2280 from being rewritten or the storage unit 2280 from being replaced with another storage device. Therefore, the storage unit 2280 is preferably implemented by a storage device having high tamper resistance. As such a storage device, for example, a storage device implemented by using a hardware security module (HSM) is exemplified.

The trail provision apparatus 2200 may be implemented by a single computer 600 or may be implemented by a plurality of computers 600. In the latter case, the configuration of each computer 600 need not be the same, but may be different.

### <Processing Flow>

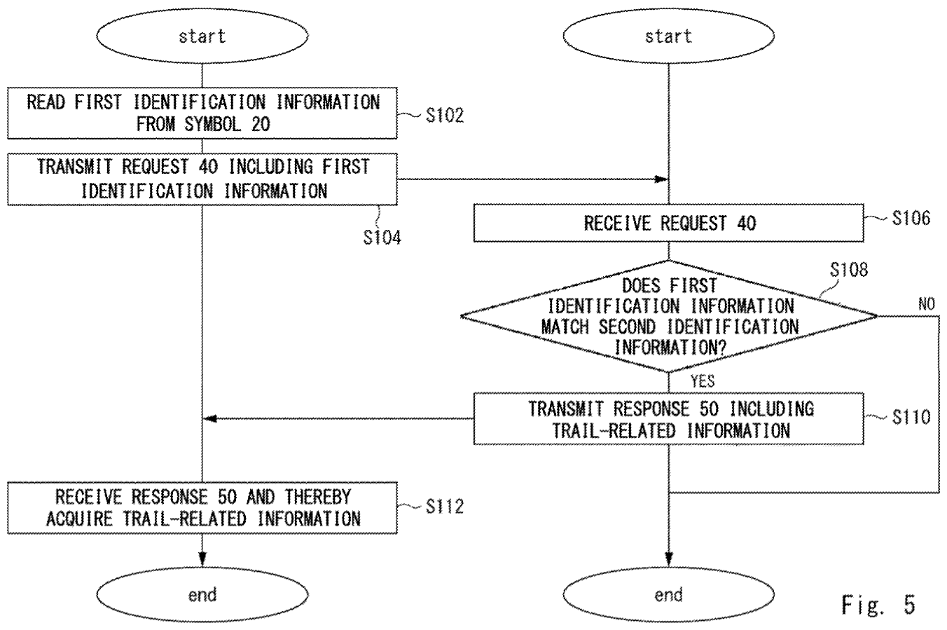

FIG. 5 is a flowchart illustrating an example of a flow of processing executed by the trail collection system 2000 according to the first example embodiment. The read unit 2120 reads the first identification information from the symbol 20 (S102). The transmission unit 2140 transmits the request 40 including the first identification information (S104).

The reception unit 2220 receives the request 40 (S106). The determination unit 2240 determines whether the first identification information being included in the request 40 matches the second identification information stored in the storage unit 2280 (S108). When these pieces of the information do not match each other (S108: NO), the flow of FIG. 4 ends. When these pieces of the information match each other (S108: YES), the transmission unit 2260 transmits the response 50 including the trail-related information (S110).

The reception unit 2160 receives the response 50 and thereby acquires the trail information (S112).

### <Reading of First Identification Information: S102>

The read unit 2120 reads the first identification information from the symbol 20 (S102). Note that, various existing techniques can be used as the technique for reading data represented by a symbol from that symbol. For example, it is assumed that the symbol 20 is a code representing encoded identification information. In such a case, the read unit 2120 acquires an image acquired by capturing the code with a camera, performs decoding processing for determining identification information from the code on the image, and thereby determines the first identification information. Further, for example, it is assumed that the symbol 20 is a character string representing the first identification information. In such a case, the read unit 2120 acquires an image acquired by capturing the character string with a camera, performs character recognition processing on the image, and thereby determines the first identification information.

In a case where the image of the symbol 20 is acquired and analyzed in such a way, the trail acquisition apparatus 2100 includes a camera for capturing the symbol 20 and generating the image thereof. The user of the trail acquisition apparatus 2100 causes the trail acquisition apparatus 2100 to perform processing of reading the first identification information from the symbol 20 by, for example, operating a camera provided in the trail acquisition apparatus 2100 and causing the camera to capture an image of the symbol 20.

In another example, the trail acquisition apparatus 2100 may include a reader (such as a barcode reader, a two-dimensional code reader, or an optical character recognition (OCR) reader) configured to read identification information from a code and output the identification information. In such a case, the user of the trail acquisition apparatus 2100 operates the reader to cause the reader to execute processing of reading the first identification information from the symbol 20. As a result, the read unit 2120 acquires the first identification information from the reader.

### <Transmission of Request 40: S104>

The transmission unit 2140 transmits the request 40 including the first identification information (S104). The transmission unit 2140 may generate and transmit the request 40 in response to the first identification information being read by the read unit 2120, or may generate and transmit the request 40 in response to other causes (for example, a predetermined user operation).

For example, the transmission unit 2140 broadcasts the request 40 by wireless communication. The method of wireless communication being used by the transmission unit 2140 may be of any kind. For example, the transmission unit 2140 broadcasts the request 40 as a Bluetooth (registered trademark) advertisement packet. As a result, each trail provision apparatus 2200 receives the request 40.

In addition, for example, the trail acquisition apparatus 2100 may broadcast the request 40 over the wireless LAN. In such a case, for example, the trail acquisition apparatus 2100 may function as an access point of the wireless LAN, and each trail provision apparatus 2200 connects to the access point. For example, the transmission unit 2140 broadcasts connection information for connecting to the access point in a method by which transmission can be performed not via the wireless LAN (for example, in the above-described Bluetooth (registered trademark) advertisement packet). Specifically, the connection information indicates a pair of a service set identifier (SSID) and a key (password). Each of the trail provision apparatuses 2200 is configured in advance to connect to the access point specified by the SSID indicated by the connection information by using the key indicated by the connection information in response to the reception of the connection information.

When each of the trail provision apparatuses 2200 is connected to the access point (the trail acquisition apparatus 2100) in this manner, as a result, the trail acquisition apparatus 2100 and each of the trail provision apparatuses 2200 are connected to the same wireless LAN. Therefore, the transmission unit 2140 broadcasts the request 40 on the wireless LAN. Each trail provision apparatus 2200 receives the request 40 broadcasted in this manner. The broadcast may be an L2 layer broadcast or an L3 layer broadcast.

In addition, for example, the trail acquisition apparatus 2100 may connect to the wireless LAN to which the trail provision apparatus 2200 is connected in advance, and then broadcast the request 40. For example, it is assumed that an access point of the wireless LAN is provided around an installation location of the trail provision apparatus 2200, and the trail provision apparatus 2200 is always connected to the access point. In such a case, when the trail acquisition apparatus 2100 connects to the access point, the trail acquisition apparatus 2100 and the trail provision apparatus 2200 are connected to the same wireless LAN. Therefore, the transmission unit 2140 broadcasts the request 40 on the wireless LAN.

When the trail acquisition apparatus 2100 connects to the wireless LAN in such a manner, the trail acquisition apparatus 2100 needs to identify, for the wireless LAN to which the trail provision apparatus 2200 associated with the target object is connected, the SSID and the key for connecting to such wireless LAN. For example, information associating the identification information of the trail provision apparatus 2200 with the SSID and the key for connecting to the wireless LAN to which the trail provision apparatus 2200 is connected is stored in advance in a storage device accessible from the trail acquisition apparatus 2100. The transmission unit 2140 acquires, from such a storage device, the SSID and the key associated with the first identification information of the trail provision apparatus 2200 read by the read unit 2120, and connects to the wireless LAN by using that SSID and that key.

The request 40 may further include information other than the first identification information. For example, the transmission unit 2140 includes the identification information of the trail acquisition apparatus 2100 in the request 40. For example, as such the identification information, it is possible to use a Bluetooth (registered trademark) device address, a media access control (MAC) address, an Internet protocol (IP) address, a universally unique identifier (UUID), or the like that is stored in advance by the trail acquisition apparatus 2100. In addition, for example, the transmission unit 2140 may generate data (for example, a random number) having a sufficiently high probability of becoming unique, and may use such data as identification information of the trail acquisition apparatus 2100.

In addition, for example, the request 40 may include information (hereinafter, referred to as condition information) indicating a condition related to the trail information to be acquired from the trail provision apparatus 2200. The condition related to the trail information may be, for example, a condition related to various attributes of the trail information. The attribute of the trail information is, for example, the type of the trail information, the creator of the trail information, the generation date and time of the trail information, or the like.

The transmission unit 2140 may encrypt the request 40. For example, a public key associated with the first identification information read by the read unit 2120 is being used to encrypt the request 40. In such a case, information that associates the identification information of the trail provision apparatus 2200 with the public key of the trail provision apparatus 2200 is stored in advance in a storage device accessible from the trail acquisition apparatus 2100. The transmission unit 2140 acquires, from the storage device, the public key associated with the first identification information read by the read unit 2120, and encrypts the request 40 with the public key.

### <Reception of Request 40: S106>

The reception unit 2220 receives the request 40 (S106). Herein, an existing technique can be used as a technique of receiving broadcast data. When managed objects 10 other than the target object are also located near the trail acquisition apparatus 2100, the request 40 may also be received by the trail provision apparatuses 2200 associated with the managed objects 10 other than the target object. Therefore, an operation of the trail provision apparatus 2200 described below is executed by each trail provision apparatus 2200 that has received the request 40.

When the request 40 is being encrypted, the reception unit 2220 decrypts the request 40. Herein, the trail provision apparatus 2200 decrypts the request 40 by using its own private key. The private key is stored in any storage device (for example, the storage unit 2280) of the trail provision apparatus 2200. When the trail provision apparatus 2200 is unable to decrypt the request 40 with its own private key, it is considered that the request 40 is not intended for that trail provision apparatus 2200. Therefore, when the request 40 cannot be decrypted, the trail provision apparatus 2200 does not need to perform further processing on the request 40.

### <Matching Determination of Identification Information: S108>

The determination unit 2240 determines whether the first identification information indicated by the request 40 matches the second identification information stored in the storage unit 2280 (S108). When these pieces of information match each other (S108: YES), the response 50 is transmitted (that is, trail information is provided to the trail acquisition apparatus 2100). Meanwhile, when these pieces of information do not match each other (S108: NO), the response 50 is not transmitted (that is, the trail information is not provided to the trail acquisition apparatus 2100).

As described above, the request 40 may be received by the plurality of trail provision apparatuses 2200. However, in the trail provision apparatuses 2200 other than the trail provision apparatus 2200 associated with the target object, the first identification information and the second identification information do not match. Therefore, the trail-related information regarding the managed objects 10 other than the target object is not transmitted to the trail acquisition apparatus 2100.

Further, in a case where the symbol 20 attached to the target object is not authentic (such as a case where the symbol 20 is improperly replaced), the first identification information and the second identification information do not match each other even in the trail provision apparatus 2200 associated with the target object, and thus the trail-related information is not transmitted. Therefore, the trail acquisition apparatus 2100 is able to acquire the trail-related information only when the authentic symbol 20 is attached to the target object. Thus, the trail acquisition apparatus 2100 is able to acquire authentic trail-related information regarding the target object. In other words, the authenticity of the association between the target object and the trail-related information is ensured.

### <Transmission of Response 50: S110>

When the first identification information and the second identification information match each other (S108: YES), the transmission unit 2260 transmits the response 50 including the trail-related information (S110). In order to generate the response 50, the transmission unit 2260 acquires the trail information from the storage unit 2290. Note that, the trail information to be used for generating the response 50 may be all or a part of the trail information stored in the storage unit 2290. In the latter case, for example, the transmission unit 2260 includes, in the response 50, the trail information that matches conditions indicated by the condition information included in the request 40, or a hash value of such the trail information. In addition, for example, the transmission unit 2260 may include, in the response 50, the trail information that matches a condition determined in advance or a hash value of such the trail information.

Any condition may be adopted as the condition determined in advance. For example, it is conceivable to adopt a condition of “generated in a predetermined period of time in the past (for example, in the past one month or in the past one year) based on the present time”.

When the hash value of the trail information is to be included in the response 50, the transmission unit 2260 computes the hash value of the acquired trail information by using a predetermined hash function. Then, a response 50 including the computed hash value is generated. Note that the response 50 may include both the trail information and the hash value of the trail information.

The response 50 may be broadcasted in a manner similar to that of broadcasting the request 40, or may be unicast to the trail acquisition apparatus 2100. In the latter case, for example, the transmission unit 2260 uses, as a destination address, the address of the trail acquisition apparatus 2100 acquired when the request 40 is received.

Herein, when the response 50 is broadcasted, the trail acquisition apparatus 2100 needs to be able to determine whether the received response 50 is a response to the request 40 transmitted by itself. Therefore, for example, in a case where the identification information of the trail acquisition apparatus 2100 is included in the request 40, the transmission unit 2260 includes such the identification information in the response 50. The trail acquisition apparatus 2100 determines whether the identification information of the trail acquisition apparatus 2100 indicated in the received response 50 matches the identification information of itself. Thus, it is possible to determine whether the received response 50 is a response to the request 40 transmitted by itself.

When the data size of the trail-related information is large, it is preferable to adopt a wireless communication method (for example, communication via a wireless LAN) by which it is easy to handle a large data size. For example, when the trail information itself is included in the response 50 instead of the hash value of the trail information, the data size may increase. When the data size is large as described above, a plurality of responses 50 may be transmitted to one request 40.

The transmission unit 2260 may include an electronic signature in the response 50. For example, the transmission unit 2260 generates an electronic signature from the trail-related information included in the response 50 by using the private key of the trail provision apparatus 2200 including that transmission unit 2260.

In addition, for example, the transmission unit 2260 may encrypt the response 50 by using the public key of the trail acquisition apparatus 2100. Whether to encrypt the response 50 may be fixedly determined in advance or may be determined by the transmission unit 2260 each time. In the latter case, for example, when the request 40 received by the reception unit 2220 is encrypted, the transmission unit 2260 encrypts the response 50. Meanwhile, when the request 40 received by the reception unit 2220 is not encrypted, the transmission unit 2260 does not encrypt the response 50.

Encryption of the response 50 is performed by using the public key of the trail acquisition apparatus 2100. For example, the public key of the trail acquisition apparatus 2100 is stored in a storage device accessible from the trail provision apparatus 2200, in association with the identification information of the trail acquisition apparatus 2100. The transmission unit 2260 acquires the identification information of the trail acquisition apparatus 2100 from the request 40, and acquires the public key associated with the identification information from the storage device. Then, the transmission unit 2260 encrypts the response 50 with the acquired public key.

### <Reception of Response 50: S112>

The reception unit 2160 receives the response 50 (S112). As a result, the reception unit 2160 is able to acquire the trail-related information included in the response 50.

Note that, when the identification information of the trail acquisition apparatus 2100 is included in the request 40, the trail acquisition apparatus 2100 may use the trail-related information included in the response 50 only when the identification information of the trail acquisition apparatus 2100 included in the response 50 matches the identification information of itself. Thereby, in a situation where a plurality of trail acquisition apparatuses 2100 are being operated, each trail acquisition apparatus 2100 is able to distinguish the response 50 to the request 40 transmitted from itself from the response 50 to the request 40 transmitted by other trail acquisition apparatuses 2100.

When the electronic signature is included in the response 50, the reception unit 2160 decrypts the electronic signature by using the public key of the trail provision apparatus 2200 associated with the first identification information acquired by the read unit 2120. Then, the reception unit 2160 determines whether the data acquired by the decryption matches the trail-related information included in the response 50. When the acquired data and the trail-related information do not match each other, there is a possibility that the trail-related information has been tampered with. Therefore, the trail acquisition apparatus 2100 may use the trail-related information included in the response 50, only when the acquired data and the trail-related information match each other. Further, when the acquired data and the trail-related information do not match each other, the trail acquisition apparatus 2100 may output a warning that there is a possibility that the trail-related information has been tampered with.

In a case where the response 50 is encrypted, the reception unit 2160 decrypts the response 50. The private key of the trail acquisition apparatus 2100 is used to decrypt the response 50.

### <Other Functions>

In order to more reliably ensure the authenticity of the trail of the managed object 10, the trail acquisition apparatus 2100 may determine whether the response 50 has been transmitted from the trail provision apparatus 2200 that is associated with the target object, based on the radio wave intensity of a radio signal indicating the response 50. Herein, when the first identification information is read from the symbol 20 attached to the target object, the trail acquisition apparatus 2100 and the trail provision apparatus 2200 associated with the target object are located at a short distance from each other. Therefore, when being received by the trail acquisition device 2100, it is considered that the radio wave intensity of the radio signal transmitted from the trail provision apparatus 2200 associated with the target object is stronger relative to the radio wave intensity of the radio signal transmitted from the trail provision apparatus 2200 associated with other managed objects 10.

Therefore, when receiving the response 50 from the trail provision apparatus 2200, the trail acquisition apparatus 2100 determines whether the radio wave intensity of the radio signal indicating the response 50 is equal to or greater than a threshold. When it is determined that the radio wave intensity of the radio signal is not equal to or greater than the threshold, the trail acquisition apparatus 2100 determines that the received response 50 is not a response to the request 40 transmitted by itself.

Meanwhile, when it is determined that the radio wave intensity of the radio signal is equal to or greater than the threshold, for example, the trail acquisition apparatus 2100 determines that the received response 50 is a response to the request 40 transmitted by itself. However, in such a case, the trail acquisition apparatus 2100 may further accurately determine whether the received response 50 is a response to the request 40 transmitted by itself, taking into consideration other information such as the identification information of the trail acquisition apparatus 2100 included in the response 50.

### <Usage Example of Acquired Trail>

The trail information acquired from the trail provision apparatus 2200 or the hash value of the trail information may be used in any way. For example, it is assumed that a system which stores and shares trails of the managed objects 10 in a secure shared storage system such as a blockchain is operated. In such a case, the trail acquisition apparatus 2100 is used to acquire the trail information or the hash value of the trail information for each managed object 10, and the acquired information is stored in the shared storage system. Thereby, the authenticity of the trail managed by the shared storage system can be ensured.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

Note that, in the above-described examples, the program may be stored by using various types of non-transitory computer-readable media and provided to a computer. Non-transitory computer-readable media include various types of tangible storage media. Examples of the non-transitory computer-readable media include magnetic recording media (e.g., flexible disk, magnetic tape, and hard disk drive), magneto-optical recording media (e.g., magneto-optical disk), CD-ROM, CD-R, CD-R/W, and semiconductor memories (e.g., mask ROM, programmable ROM (PROM), erasable PROM (EPROM), flash ROM, and RAM). The program may also be provided to a computer by using various types of transitory computer-readable media. Examples of the transitory computer-readable media include electrical signals, optical signals, and electromagnetic waves. The transitory computer-readable medium may supply the program to the computer via a wired communication path such as an electric wire and an optical fiber, or a wireless communication path.

The whole or part of the example embodiments described above can be described as, but not limited to, the following supplementary notes.

### (Supplementary Note 1)

A trail collection system comprising a trail provision apparatus and a trail acquisition apparatus,
wherein the trail acquisition apparatus includes:
   a read unit configured to read, from a symbol attached to a managed object, first identification information represented by the symbol;
   a transmission unit configured to transmit a request including the first identification information; and
   a reception unit configured to receive a response, and
wherein the trail provision apparatus includes:
   a reception unit configured to receive the request;
   a determination unit configured to determine whether the first identification information included in the request matches second identification information stored in the trail provision apparatus; and
   a transmission unit configured to transmit, when the first identification information matches the second identification information, the response including trail information stored in the trail provision apparatus or the response including a hash value of the trail information.

### (Supplementary Note 2)

The trail collection system according to supplementary note 1,
wherein the trail provision apparatus is the managed object, or the trail provision apparatus is provided inside the managed object.

### (Supplementary Note 3)

The trail collection system according to supplementary note 1 or 2,
wherein the trail acquisition apparatus is configured to function as an access point of a wireless local area network (LAN),
wherein the transmission unit of the trail acquisition apparatus transmits connection information to be used for connection to the access point,
wherein the reception unit of the trail provision apparatus receives the connection information and connects to the access point by using the connection information, and
wherein the request and the response are transmitted via the wireless LAN.

### (Supplementary Note 4)

The trail collection system according to any one of supplementary notes 1 to 3,
wherein the transmission unit of the trail acquisition apparatus encrypts the request with a public key associated with the first identification information, and
wherein the reception unit of the trail provision apparatus decrypts the request with a private key of the trail provision apparatus.

### (Supplementary Note 5)

The trail collection system according to any one of supplementary notes 1 to 4,
wherein the transmission unit of the trail provision apparatus is configured to:
   generate an electronic signature from the trail information or a hash value of the trail information by using a private key of the trail provision apparatus; and
   transmit the electronic signature by including the electronic signature in the request, and
wherein the reception unit of the trail acquisition apparatus is configured to:
   decrypt the electronic signature included in the request with a public key associated with the first identification information; and
   determine whether data acquired by the decryption match the trail information or the hash value of the trail information included in the response.

### (Supplementary Note 6)

A trail collection method executed by a trail provision apparatus and a trail acquisition apparatus, comprising:
the trail acquisition apparatus reads, from a symbol attached to a managed object, first identification information represented by the symbol;
the trail acquisition apparatus transmits a request including the first identification information;
the trail provision apparatus receives the request;
the trail provision apparatus determines whether the first identification information included in the request matches second identification information stored in the trail provision apparatus;
the trail provision apparatus, transmits, when the first identification information matches the second identification information, a response including trail information stored in the trail provision apparatus or a response including a hash value of the trail information; and
the trail acquisition apparatus receives the response.

### (Supplementary Note 7)

The trail collection method according to supplementary note 6,
wherein the trail provision apparatus is the managed object, or the trail provision apparatus is provided inside the managed object.

### (Supplementary Note 8)

The trail collection method according to supplementary note 6 or 7, comprising:
the trail acquisition apparatus is configured to function as an access point of a wireless local area network (LAN);
the trail acquisition apparatus transmits connection information to be used for connection to the access point; and
the trail provision apparatus receives the connection information and connects to the access point by using the connection information, wherein the request and the response are transmitted via the wireless LAN.

### (Supplementary Note 9)

The trail collection method according to any one of supplementary notes 6 to 8, comprising:
the trail acquisition apparatus encrypts the request with a public key associated with the first identification information; and
the trail provision apparatus decrypts the request with a private key of the trail provision apparatus.

### (Supplementary Note 10)

The trail collection method according to any one of supplementary notes 6 to 9, comprising:
the trail provision apparatus performs:
   generating an electronic signature from the trail information or a hash value of the trail information by using a private key of the trail provision apparatus; and
   transmitting the electronic signature by including the electronic signature in the request, and
the trail acquisition apparatus performs:
   decrypting the electronic signature included in the request with a public key associated with the first identification information; and
   determining whether data acquired by the decryption match the trail information or the hash value of the trail information included in the response.

### (Supplementary Note 11)

A trail provision apparatus comprising:
a reception unit configured to receive a request including first identification information that is read from a symbol attached to a managed object;
a determination unit configured to determine whether the first identification information included in the request matches second identification information stored in the trail provision apparatus; and
a transmission unit configured to transmit, when the first identification information matches the second identification information, a response including trail information stored in the trail provision apparatus or a response including a hash value of the trail information.

### (Supplementary Note 12)

The trail provision apparatus according to supplementary note 11,
wherein the request is transmitted by an apparatus that is configured to:
   function as an access point of a wireless local area network (LAN); and
   transmit connection information to be used for connection to the access point, and
wherein the reception unit performs:
   receiving the connection information and connects to the access point by using the connection information; and
   receiving the request via the wireless LAN.

### (Supplementary Note 13)

The trail provision apparatus according to supplementary note 11 or 12,
wherein the request is encrypted with a public key associated with the first identification information, and
wherein the reception unit decrypts the request with a private key of the trail provision apparatus.

### (Supplementary Note 14)

The trail provision apparatus according to any one of supplementary notes 11 to 13,
wherein the transmission unit generates an electronic signature from the trail information or the hash value of the trail information by using a private key of the trail provision apparatus, and transmits the electronic signature by including the electronic signature in the request.

### (Supplementary Note 15)

A trail provision method executed by a computer, comprising:
a reception step of receiving a request including first identification information that is read from a symbol attached to a managed object;
a determination step of determining whether the first identification information included in the request matches second identification information stored in the computer; and
a transmission step of transmitting, when the first identification information matches the second identification information, a response including trail information stored in the computer or a response including a hash value of the trail information.

### (Supplementary Note 16)

The trail provision method according to supplementary note 15,
wherein the request is transmitted by an apparatus that is configured to:
   function as an access point of a wireless local area network (LAN), and
   transmit connection information to be used for connection to the access point, and
wherein the reception step includes:
   receiving the connection information and connecting to the access point by using the connection information; and
   receiving the request via the wireless LAN.

### (Supplementary Note 17)

The trail provision method according to supplementary note 15 or 16,
wherein the request is encrypted with a public key associated with the first identification information, and
wherein the reception step includes decrypting the request with a private key of the computer.

### (Supplementary Note 18)

The trail provision method according to any one of supplementary notes 15 to 17,
wherein the transmission step includes generating an electronic signature from the trail information or the hash value of the trail information by using a private key of the computer, and transmitting the electronic signature by including the electronic signature in the request.

### (Supplementary Note 19)

A computer-readable medium storing a program causing a computer to execute:
a reception step of receiving a request including first identification information that is read from a symbol attached to a managed object;
a determination step of determining whether the first identification information included in the request matches second identification information stored in the computer; and
a transmission step of transmitting, when the first identification information matches the second identification information, a response including trail information stored in the computer or a response including a hash value of the trail information.

### (Supplementary Note 20)

The computer-readable medium according to supplementary note 19,
wherein the request is transmitted by an apparatus that is configured to:
   function as an access point of a wireless local area network (LAN), and
   transmit connection information to be used for connection to the access point, and
wherein the reception step includes:
   receiving the connection information and connecting to the access point by using the connection information; and
   receiving the request via the wireless LAN.

### (Supplementary Note 21)

The computer-readable medium according to supplementary note 19 or 20,
wherein the request is encrypted with a public key associated with the first identification information, and
wherein the reception step includes decrypting the request with a private key of the computer.

### (Supplementary Note 22)

The computer-readable medium according to any one of supplementary notes 19 to 21,
wherein the transmission step includes generating an electronic signature from the trail information or the hash value of the trail information by using a private key of the computer, and transmitting the electronic signature by including the electronic signature in the request.

### REFERENCE SIGNS LIST

10 MANAGED OBJECT
20 SYMBOL
40 REQUEST
50 RESPONSE
500 COMPUTER
502 BUS
504 PROCESSOR
506 MEMORY
508 STORAGE DEVICE
510 INPUT/OUTPUT INTERFACE
512 WIRELESS COMMUNICATION INTERFACE
600 COMPUTER
602 BUS
604 PROCESSOR
606 MEMORY
608 STORAGE DEVICE
610 INPUT/OUTPUT INTERFACE
612 WIRELESS COMMUNICATION INTERFACE
2000 TRAIL COLLECTION SYSTEM
2100 TRAIL ACQUISITION APPARATUS
2120 READ UNIT
2140 TRANSMISSION UNIT
2160 RECEPTION UNIT
2200 TRAIL PROVISION APPARATUS
2220 RECEPTION UNIT
2240 DETERMINATION UNIT
2260 TRANSMISSION UNIT
2280 STORAGE UNIT
2290 STORAGE UNIT

What is claimed is:

1. A trail collection system comprising a trail provision apparatus and a trail acquisition apparatus,
wherein the trail acquisition apparatus includes:
at least one memory that is configured to store instructions; and
at least one processor that is configured to execute the instructions to:
read, from a symbol attached to a managed object, first identification information represented by the symbol;
transmit a request including the first identification information; and
receive a response, and
wherein the trail provision apparatus includes:
at least one memory that is configured to store instructions; and
at least one processor that is configured to execute the instructions stored in the trail provision apparatus to:
receive the request;
determine whether the first identification information included in the request matches second identification information stored in the trail provision apparatus; and
transmit, when the first identification information matches the second identification information, the response including trail information stored in the trail provision apparatus or the response including a hash value of the trail information.

2. The trail collection system according to claim 1,
wherein the trail provision apparatus is the managed object, or the trail provision apparatus is provided inside the managed object.

3. The trail collection system according to claim 1,
wherein the at least one processor of the trail acquisition apparatus is configured further to:
function as an access point of a wireless local area network (LAN); and
transmit connection information to be used for connection to the access point,
wherein the at least one processor of the trail provision apparatus is configured further to receive the connection information and connects to the access point by using the connection information, and
wherein the request and the response are transmitted via the wireless LAN.

4. The trail collection system according to claim 1,
wherein the at least one processor of the trail acquisition apparatus is configured further to encrypt the request with a public key associated with the first identification information, and
wherein the at least one processor of the trail provision apparatus is configured further to decrypt the request with a private key of the trail provision apparatus.

5. The trail collection system according to claim 1,
wherein the at least one processor of the trail provision apparatus is configured further to:
generate an electronic signature from the trail information or a hash value of the trail information by using a private key of the trail provision apparatus; and
transmit the electronic signature by including the electronic signature in the request, and
wherein the at least one processor of the trail acquisition apparatus is configured further to:
decrypt the electronic signature included in the request with a public key associated with the first identification information; and
determine whether data acquired by the decryption match the trail information or the hash value of the trail information included in the response.

6. A trail collection method executed by a trail provision apparatus and a trail acquisition apparatus, comprising:
the trail acquisition apparatus reads, from a symbol attached to a managed object, first identification information represented by the symbol;
the trail acquisition apparatus transmits a request including the first identification information;
the trail provision apparatus receives the request;
the trail provision apparatus determines whether the first identification information included in the request matches second identification information stored in the trail provision apparatus;
the trail provision apparatus, transmits, when the first identification information matches the second identification information, a response including trail information stored in the trail provision apparatus or a response including a hash value of the trail information; and
the trail acquisition apparatus receives the response.

7. The trail collection method according to claim 6,
wherein the trail provision apparatus is the managed object, or the trail provision apparatus is provided inside the managed object.

8. The trail collection method according to claim 6, further comprising:
the trail acquisition apparatus is configured to function as an access point of a wireless local area network (LAN);
the trail acquisition apparatus transmits connection information to be used for connection to the access point; and
the trail provision apparatus receives the connection information and connects to the access point by using the connection information,
wherein the request and the response are transmitted via the wireless LAN.

9. The trail collection method according to claim 6, further comprising:
the trail acquisition apparatus encrypts the request with a public key associated with the first identification information; and
the trail provision apparatus decrypts the request with a private key of the trail provision apparatus.

10. The trail collection method according to claim 6, further comprising:
the trail provision apparatus
generates an electronic signature from the trail information or a hash value of the trail information by using a private key of the trail provision apparatus;
the trail provision apparatus transmits the electronic signature by including the electronic signature in the request;
the trail acquisition apparatus
decrypts the electronic signature included in the request with a public key associated with the first identification information; and
the trail acquisition apparatus determines whether data acquired by the decryption match the trail information or the hash value of the trail information included in the response.

11. A trail provision apparatus comprising:
at least one memory that is configured to store instructions; and
at least one processor that is configured to execute the instructions to:
receive a request including first identification information that is read from a symbol attached to a managed object;
determine whether the first identification information included in the request matches second identification information stored in the trail provision apparatus; and
transmit, when the first identification information matches the second identification information, a response including trail information stored in the trail provision apparatus or a response including a hash value of the trail information.

12. The trail provision apparatus according to claim 11,
wherein the request is transmitted by an apparatus that is configured to:
function as an access point of a wireless local area network (LAN); and
transmit connection information to be used for connection to the access point, and
wherein the at least one processor is configured further to:
receive the connection information and connects to the access point by using the connection information; and
receive the request via the wireless LAN.

13. The trail provision apparatus according to claim 11,
wherein the request is encrypted with a public key associated with the first identification information, and
wherein the at least one processor is configured further to decrypt the request with a private key of the trail provision apparatus.

14. The trail provision apparatus according to claim 11,
wherein the at least one processor is configured further to
generate an electronic signature from the trail information or the hash value of the trail information by using a private key of the trail provision apparatus; and
transmit the electronic signature by including the electronic signature in the request.

15. A trail provision method executed by a computer, comprising:
receiving a request including first identification information that is read from a symbol attached to a managed object;
determining whether the first identification information included in the request matches second identification information stored in the computer; and
transmitting, when the first identification information matches the second identification information, a response including trail information stored in the computer or a response including a hash value of the trail information.

16. The trail provision method according to claim 15,
wherein the request is transmitted by an apparatus that is configured to:
function as an access point of a wireless local area network (LAN), and
transmit connection information to be used for connection to the access point, and
wherein the reception of the request further includes:
receiving the connection information and connecting to the access point by using the connection information; and
receiving the request via the wireless LAN.

17. The trail provision method according to claim 15,
wherein the request is encrypted with a public key associated with the first identification information, and
wherein the reception of the request further includes decrypting the request with a private key of the computer.

18. The trail provision method according to claim 15,
wherein the transmission of the response further includes:
generating an electronic signature from the trail information or the hash value of the trail information by using a private key of the computer; and
transmitting the electronic signature by including the electronic signature in the request.

19. A non-transitory computer-readable medium storing a program causing a computer to execute:
receiving a request including first identification information that is read from a symbol attached to a managed object;
determining whether the first identification information included in the request matches second identification information stored in the computer; and
transmitting, when the first identification information matches the second identification information, a response including trail information stored in the computer or a response including a hash value of the trail information.

20. The non-transitory computer-readable medium according to claim 19,
wherein the request is transmitted by an apparatus that is configured to:
function as an access point of a wireless local area network (LAN), and
transmit connection information to be used for connection to the access point, and
wherein the reception of the request further includes:
receiving the connection information and connecting to the access point by using the connection information; and
receiving the request via the wireless LAN.

21. The non-transitory computer-readable medium according to claim 19,
wherein the request is encrypted with a public key associated with the first identification information, and
wherein the reception of the request further includes decrypting the request with a private key of the computer.

22. The non-transitory computer-readable medium according to claim 19,
wherein the transmission of the response includes:
generating an electronic signature from the trail information or the hash value of the trail information by using a private key of the computer; and
transmitting the electronic signature by including the electronic signature in the request.
